(19) United States
(12) Patent Application Publication
(10) Pub. No.: US 2010/0033428 A1
(43) Pub. Date: Feb. 11, 2010

(54) CURSOR MOVING METHOD AND APPARATUS FOR PORTABLE TERMINAL

(75) Inventors: Young-joon Ahn, Suwon-si (KR); Byeong-seob Ko, Suwon-si (KR); Jeong-hun Park, Yongin-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/423,325

(22) Filed: Apr. 14, 2009

(30) Foreign Application Priority Data
Aug. 6, 2008 (KR) 2008-76747

(51) Int. Cl. G09G 5/08

(52) U.S. Cl. 345/157

(57) ABSTRACT

A cursor moving method and apparatus for portable terminals is provided, by which a user is able to point to a specific location on a screen of the portable terminal by using one hand. The cursor moving method includes the operations of sensing a spatial motion of the portable terminal by using a motion sensor, extracting a direction and distance of the movement of the portable terminal from a result output from the motion sensor, and moving the cursor on a screen of the portable terminal, according to the direction and distance of the movement.

### CROSS-REFERENCE TO RELATED APPLICATION

This application claims the benefit of Korean Patent Application No. 2008-76747, filed on Aug. 6, 2008, in the Korean Intellectual Property Office, the disclosure of which is incorporated herein, by reference.

### BACKGROUND OF THE INVENTION

1. Field of the Invention

Aspects of the present invention relate to a cursor moving method and apparatus, for a portable terminal.

2. Description of the Related Art

Portable terminals, such as personal digital assistances (PDAs), personal communication systems (PCSs), and electronic-books have become widely used, due to developments in wireless telecommunication technology and computer device technology. Such devices can easily and conveniently acquire, store, and manage enormous amounts of information, and can use wireless Internet connections.

To manipulate a portable terminal, while moving or when stationary, a user presses buttons or a touch screen using a hand that holds the portable terminal. However, it is difficult for users to perform cursor moving operations, because portable terminals generally have a small screen. Therefore, a technique capable of delicately and conveniently performing a cursor moving operation is needed for portable terminals.

### SUMMARY OF THE INVENTION

Aspects of the present invention provide a cursor moving method and apparatus, for a portable terminal.

According to an aspect of the present invention, there is provided a cursor moving method for a portable terminal, the method including: sensing a movement of the portable terminal, by using a motion sensor; extracting the direction and distance of the movement, from the result of the sensing; and moving a cursor on the screen of the portable terminal, according to the direction and distance of the movement.

According to another aspect of the present invention, there is provided a cursor moving apparatus included in a portable terminal, the apparatus comprising: an input unit to manipulate the cursor; a motion sensing unit to sense the direction and distance of a movement of the portable terminal; and a control unit to extract the position of the portable terminal, on the basis of the result of the motion sensing, to move the cursor according to the position, and to control the motion of the cursor, according to a signal received from the input unit.

According to another aspect of the present invention, there is provided a computer-readable recording medium having recorded thereon a cursor moving method performed in a portable terminal, the method comprising: sensing a movement of the portable terminal, by using a motion sensor; extracting the direction and distance of the movement, using values from the motion sensor; and moving a cursor on a screen of the portable terminal, according to the direction and distance of the movement.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is a block diagram of a cursor moving apparatus of a portable terminal, according to an exemplary embodiment of the present invention;

FIG. 2 is a block diagram of a control unit of the cursor moving apparatus illustrated in FIG. 1;

FIG. 3 is a flowchart of a cursor moving method for a portable terminal, according to an exemplary embodiment of the present invention;

FIG. 4 is an exterior view of a portable terminal that performs a cursor moving operation, according to an exemplary embodiment of the present invention;

FIG. 5 illustrates movements of a pointer on a screen, according to an exemplary embodiment of the present invention; and

FIG. 6 is a conceptual view illustrating a movement of a cursor of a portable terminal, according to an exemplary embodiment of the present invention.

### DETAILED DESCRIPTION OF THE EXEMPLARY EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

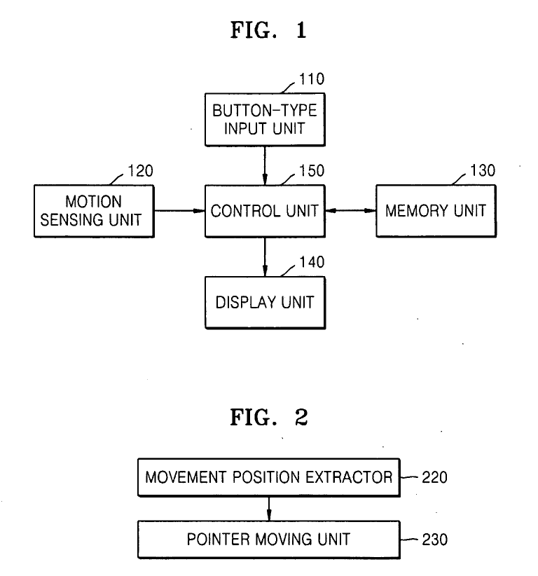

FIG. 1 is a block diagram of a cursor moving apparatus of a portable terminal, according to an exemplary embodiment of the present invention. Referring to FIG. 1, the cursor moving apparatus includes an input unit 110, a motion sensing unit 120 (motion sensor), a memory unit 130, a display unit 140, and a control unit 150.

The input unit 110 includes a plurality of number buttons, a plurality of character buttons, and at least one function button, which are used to select a desired function or input information. In particular, the input unit 110 includes a button corresponding to a left mouse button, a button corresponding to a right mouse button, and a pointer reset/hold button. The input unit 110 can be used to manipulate a cursor on a screen of a portable terminal.

The motion sensing unit 120 may include various sensors. In the present exemplary embodiment, an acceleration sensor and/or a direction sensor can be used as the motion sensing unit 120. The motion sensing unit 120 senses movements of the portable terminal and transmits information about the movements to the control unit 150. The movement information may relate to the direction of a movement and the distance of the movement. The movement direction refers to left, right, upward, and/or downward directions, with respect to a central point of the portable terminal. The distance of the movement may be expressed as a predetermined figure that represents the distance of the movement. Acceleration sensors and direction sensors (or gyroscopes) are well known, and thus, a detailed description thereof is omitted.

The memory unit 130 includes a read only memory (ROM) and a random access memory (RAM), which can store programs and data. In particular, the memory unit 130 can store information about movements of the portable terminal, button pressing patterns, and external movement patterns.

The display unit 140 may be a liquid crystal display (LCD), a thin film transistor (TFT) display, or an organic electro luminescence (EL) display. The display unit 140 displays a cursor that can point to various types of information received from the control unit 150 and by pointing to specific positions on the display unit 140. The control unit 150 extracts a position of the portable terminal, on the basis of the direction and distance of a movement of the portable terminal, which are sensed by the motion sensing unit 120. The control unit 150 moves the cursor on the display unit 140, according to the movement of the portable terminal.

FIG. 2 is a block diagram of the control unit 150. Referring to FIG. 2, the control unit 150 includes a position extractor 220, and a cursor control unit 230. The position extractor 220 extracts a movement direction and a movement distance of the portable terminal, on the basis of results output from the motion sensing unit 120.

The cursor control unit 230 moves the cursor on the screen of the portable terminal, according to the movement direction and movement distance of the portable terminal extracted by the movement position extractor 220. More specifically, the cursor control unit 230 moves the cursor in an opposite direction to the movement direction of the portable terminal. In addition, the cursor control unit 230 calculates a ratio between the movement distance of the portable terminal and a movement distance of the cursor, and moves the cursor according to the ratio.

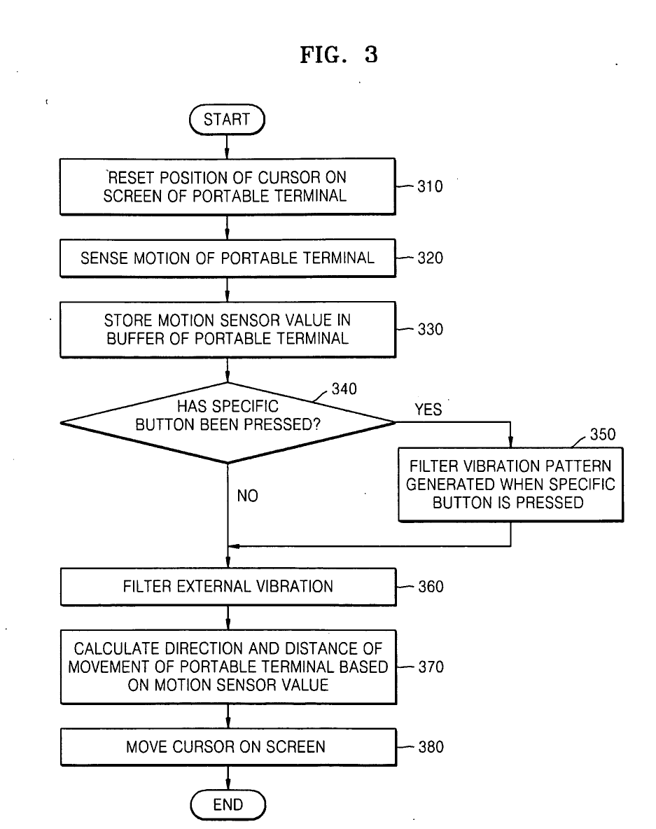

FIG. 3 is a flowchart of a cursor moving method for a portable terminal, according to an exemplary embodiment of the present invention. In operation 310, the position of a cursor on a screen of a portable terminal is reset.

In operation 320, a movement of the portable terminal is sensed by a motion sensor. The motion sensor can detect a direction and/or a distance of the movement of the portable terminal.

In operation 330, information detected by the motion sensor is stored in a buffer of the portable terminal. In operation 340, a determination is made, as to whether a button has been pressed to manipulate the cursor.

When a button is pressed, the portable terminal vibrates, and the motion sensor reacts to the vibration. The vibration of the portable terminal is not reflected in the movement of the cursor. In other words, a vibration pattern, which is typically generated when a button is pressed, is filtered out of movement information generated by the motion sensor.

In operation 350, if a button was pressed, the resulting vibration pattern is filtered. The filtering may be performed using a method of consistently controlling a button input value, according to a predefined calculation expression.

In operation 360, after the vibration pattern is filtered, any external vibration, such as a vibration from a bus or a subway train, is filtered. For example, if a user tries to perform a cursor moving operation while riding on a subway train, motions resulting from the subway train are filtered out. To remove a vibration of the train, which affects the motion of the portable terminal, a stored vibration pattern of the train is subtracted from information output by an acceleration sensor of the portable terminal. Accordingly, modified movement information may be determined, by subtracting a vibration pattern value associated with an external event from the motion sensor information.

In operation 370, the direction and distance of a movement of the portable terminal are calculated, based on the modified movement information. The cursor is moved in an opposite direction to the direction of the movement of the portable terminal. The distance of the movement of the cursor may be calculated using Equation 1:

$$Movement distance ( I ) = - {\int }_{{t}_{0}}^{{t}_{1}} a d t \qquad ( 1 )$$

In Equation 1, “t” indicates time, and “a” indicates acceleration.

In another exemplary embodiment, a ratio of the movement distance of the portable terminal to the movement distance of the cursor is 1:1. Therefore, the cursor appears to a user to be stationary, when the portable terminal is moved. The ratio of the movement distance of the portable terminal to the movement distance of the cursor can be adjusted to provide accurate cursor positioning. For example, the movement distance I of the cursor can be scaled according to a preferred ratio.

For example, when the movement distance of the cursor is set to one fifth of the movement distance of the portable terminal, if the portable terminal moves 1 cm, the cursor moves 2 mm. Thus, the cursor can be moved in units of several pixels, even on a small screen of the portable terminal. Therefore, users can delicately move the cursor, while observing the screen of the portable terminal.

In operation 380, the cursor is moved on the screen, according to the movement of the portable terminal. In other words, the cursor moves in an opposite direction to the direction the portable terminal is moved.

According to aspects of the present invention, the cursor appears to a user as having inertia on a screen space. Thus, a user can easily learn to maneuver the cursor. Furthermore, a user can easily perform web surfing, by manipulating a portable terminal using only one hand.

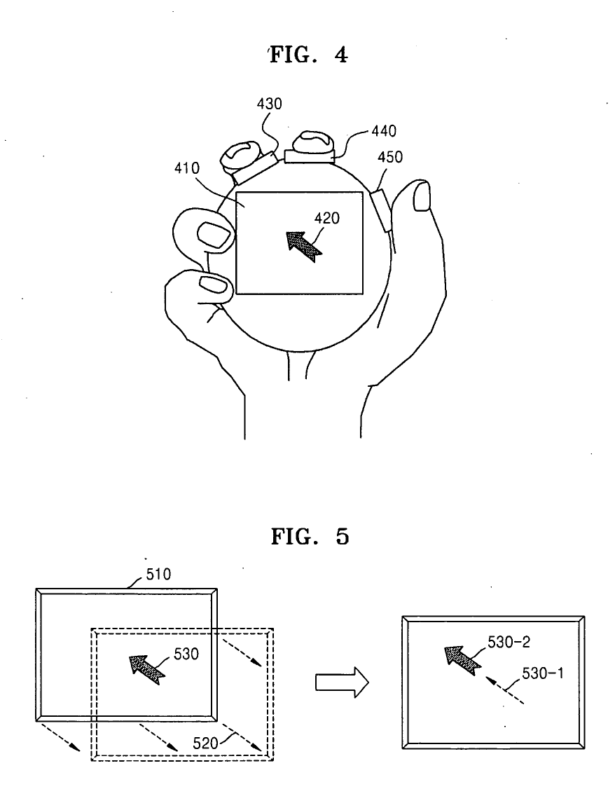

FIG. 4 is an exterior view of a portable terminal that performs a cursor moving operation, according to an exemplary embodiment of the present invention. Referring to FIG. 4, the portable terminal includes an LCD 410, a cursor 420, a left button 430, a right button 440, and a function button 450. Pressing the function button 450 corrects the movement of the cursor, by resetting, or holding, the position of the cursor 420.

Referring to FIG. 4, when a user holds the portable terminal, the user may press the left button 430 using an index finger and the right button 440 using a middle finger, which is similar to operating a desktop mouse. Another finger can easily correct the movement of the cursor 420, by pressing the function button 450.

When a user holds the portable terminal with one hand, the user can move of the cursor 420 and press the buttons 430, 440, and 450, using only one hand. In another exemplary embodiment, the positions of the buttons 430, 440, and 450 may be changed. For example, the left button 430 and the right button 440 may be installed at positions corresponding to the thumb, so as to be easily pressed by the thumb.

In still another exemplary embodiment, other buttons, such as a scroll wheel or page up/page down buttons may be further attached to the portable terminal, so as to be operated by a single hand of a user. For example, a ratio control button, to control the ratio between the movement distance of the portable terminal and the movement distance of the cursor 420, may be attached to a specific portion of the portable terminal.

FIG. 5 illustrates a movement of a cursor 530 on a screen, according to an exemplary embodiment of the present invention. Referring to FIG. 5, when a portable terminal is moved in a direction 520, the cursor 530 is moved in an opposite direction 520, on a screen 510 of the portable terminal. That is, the cursor 530 is moved from a position “530-1” to a position “530-2”. Accordingly, the cursor 530 may give the user an impression that the cursor 530 has inertia and resists the movements of the portable terminal.

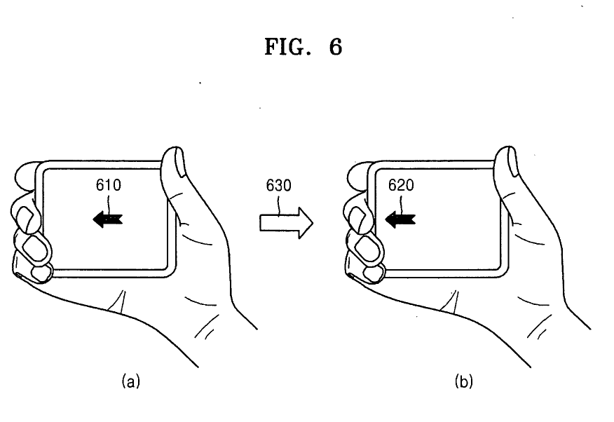

FIG. 6 is a conceptual view illustrating the movement of a cursor of a portable terminal, according to an exemplary embodiment of the present invention. In FIG. 6, side (a) illustrates a cursor 610 displayed on a screen of the portable terminal, before the portable terminal moves. When a user moves the portable terminal in direction 630 (to the right), the cursor 610 moves to the left, i.e., moves in an opposite direction to the direction 630 in which the portable terminal is moved, as illustrated in side (b).

Aspects of the present invention can also be embodied as computer readable codes on a computer readable recording medium. The computer readable recording medium can be any data storage device that can store data, which can be thereafter read by a computer system. Examples of the computer readable recording medium include read-only memory (ROM), random-access memory (RAM), CD-ROMs, magnetic tapes, hard disks, floppy disks, optical data storage devices, and carrier waves (such as data transmission through the Internet). The computer readable recording medium can also be distributed over network coupled computer systems, so that the computer readable code is stored and executed in a distributed fashion.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A cursor moving method performed on a portable terminal, the method comprising:
sensing a movement of the portable terminal using a motion sensor;
extracting the direction and distance of the movement using a result output from the motion sensor; and
moving the cursor on a screen of the portable terminal, according to the extracted direction and distance.

2. The cursor moving method of claim 1, wherein the sensing of the movement of the portable terminal comprises measuring the direction and distance of the movement of the portable terminal.

3. The cursor moving method of claim 1, further comprising:
determining whether a button has been pressed, after the sensing of the movement of the portable terminal; and
if the button has been pressed, filtering a vibration pattern generated when the button has been pressed.

4. The cursor moving method of claim 3, wherein the filtering of the vibration pattern comprises consistently controlling a value for the button pressing according to a predefined formula.

5. The cursor moving method of claim 1, wherein the extracting of the direction and distance comprises subtracting a preset external vibration pattern value from the results output from the motion sensor.

6. The cursor moving method of claim 1, wherein the moving of the cursor comprises moving the cursor in a direction opposite to the direction of the movement of the portable terminal.

7. The cursor moving method of claim 1, wherein the moving of the cursor comprises moving the cursor a distance that is a fraction of the distance of the movement of the portable terminal.

8. The cursor moving method of claim 7, wherein the distance the cursor is moved is set according to a user-set ratio.

9. A cursor moving apparatus included in a portable terminal, the apparatus comprising:
an input unit to manipulate the position of a cursor;
a motion sensing unit to sense the direction and distance of a movement of the portable terminal; and
a control unit to extract a position of the portable terminal, on the basis of the direction and distance of the movement of the portable terminal, to move the cursor according to the position of the portable terminal, and to move the cursor according to a signal received from the input unit.

10. The cursor moving apparatus of claim 9, wherein the input unit comprises a button corresponding to a left mouse button, a button corresponding to a right mouse button, and a pointer reset/hold button.

11. The cursor moving apparatus of claim 9, wherein the input unit further comprises a ratio control button to set a ratio between a distance the cursor is moved and a distance the portable terminal is moved.

12. The cursor moving apparatus of claim 9, wherein the control unit comprises:
a movement position extractor to determine the position of the portable terminal, according to the direction and distance of the movement of the portable terminal sensed by the motion sensor; and
a cursor control unit to control the position of the cursor on a screen of the portable terminal, according to the direction and distance of the movement of the portable terminal.

13. The cursor moving apparatus of claim 9, wherein the cursor control unit moves the cursor in a first direction when the portable terminal is moved in a second opposing direction.

14. The cursor moving apparatus of claim 9, wherein the cursor control unit moves the cursor a distance that is a fraction of the distance of the movement of the portable terminal.

15. A computer-readable recording medium having recorded thereon a cursor moving method performed in a portable terminal, the method comprising:
sensing a movement of the portable terminal using a motion sensor;
determining the direction and distance of the movement using a result output from the motion sensor; and
moving a cursor on a screen of the portable terminal, according to the direction and distance of the movement.

16. The cursor moving apparatus of claim 9, wherein the controller filters vibrations out of results output from the motion sensor.

17. A cursor moving method performed on a portable terminal, the method comprising:
detecting movements of the portable terminal using a motion sensor;
filtering vibrations from a result output from the motion sensor, to extract a direction and distance of a user-made movement; and
moving a cursor on a screen of the portable terminal, according to the extracted direction and distance.

18. The cursor moving method of claim 17, wherein the filtering of the vibrations comprises comparing the result to a database.

19. The cursor moving method of claim 17, wherein the filtering of the vibrations comprises filtering out vibrations produced by the portable terminal.
